(19) United States
(12) Patent Application Publication
(10) Pub. No.: US 2012/0049729 A1
(43) Pub. Date: Mar. 1, 2012

(54) GETTER ASSEMBLY AND MANUFACTURING METHOD THEREOF

(75) Inventors: Hyun-seung CHO, Anyang-si (KR); Dong-su CHANG, Cheonan-si (KR); Jae-young LEE, Cheonan-si (KR)

(73) Assignee: SAMSUNG ELECTRONICS CO., LTD., Suwon-si (KR)

(21) Appl. No.: 13/189,958

(22) Filed: Jul. 25, 2011

(30) Foreign Application Priority Data
Aug. 30, 2010 (KR) 2010-0084095

(51) Int. Cl. H01J 17/24; H01J 9/39

(52) U.S. Cl. 313/554; 445/55

(57) ABSTRACT

A getter assembly which is mounted in a getter chamber is provided. The getter assembly comprises a plurality of getter, support units to support the plurality of getter. When the getter assembly is mounted the getter chamber, the support unit is elastically deformed to create a pressing force against the plurality of spacer, thereby the getter assembly maintain fixedly in the getter chamber.

### CROSS-REFERENCE TO RELATED APPLICATION

This application claims priority from Korean Patent Application No. 10-2010-0084095, filed on Aug. 30, 2010, in the Korean Intellectual Property Office, the disclosure of which is incorporated herein by reference in its entirety.

### BACKGROUND

1. Field

Exemplary embodiments relate to a getter assembly, and more particular, to a getter assembly which is mounted in a getter chamber of a display apparatus.

2. Description of the Related Art

Display apparatuses generally require a vacuum packaging process. For example, plasma display apparatuses, field emission display (FED) apparatuses and Vacuum Fluorescence Display (VFD) apparatuses need to be vacuum-packaged.

A space between an upper board and a lower board of the display apparatus can be maintained in a vacuum state by an exhaust process. A getter absorbs remaining gas between the upper board and the lower board of the display apparatus and enables a desirable vacuum value to be achieved.

It is known that a getter chamber can be used in order to mount the getter in the display apparatuses. The getter chamber is formed to fluidly communicate with the space between the upper board and the lower board and accommodates the getter so that the space between the upper board and the lower board of display apparatus can be maintained in the vacuum state.

In order to fix the getter in the getter chamber, a plasticity process using a seal frit can be used. However, while the plasticity process is performed at a high temperature, the getter may be oxidized or contaminated. Accordingly, what is needed is a technology for preventing the getter from being oxidized or contaminated when fixing the getter.

### SUMMARY

Exemplary embodiments overcome the above disadvantages and other disadvantages not described above. However, it is understood that an exemplary embodiment is not required to overcome the disadvantages described above, and an exemplary embodiment may not overcome any of the problems described above.

An aspect of an exemplary embodiment provides a getter assembly for being mounted in a getter chamber in which a plurality of spacers are formed. The getter assembly includes a plurality of getters and a support unit to support the plurality of getters. When the getter assembly is mounted in the getter chamber, the support unit may elastically deformed to create a pressing force against the plurality of spacers, thereby fixedly maintaining the getter assembly.

The support unit may include a plurality of support bars to which the plurality of getters are fixed and a coupling bar which couples the plurality of support bars.

The plurality of spacers may include a first and second spacers which are adjacent to each other and each of the plurality of support bars may include a first and second elastic deformation parts which are disposed at opposite ends of the support bars and are elastically deformed by being brought into contact with the first and the second spacers and a getter fixing part which is disposed between the first and the second elastic deformation parts and to which some of the plurality of getters are fixed.

The first and the second elastic deformation parts may be formed by bending the support bar.

The first and the second elastic deformation parts which may be elastically deformed, thereby generating the pressing force against the first and the second spacers.

The distance between open ends of the first and the second elastic deformation part of the support bar, before the first and the second elastic deformation parts are elastically deformed, may be greater than a distance between the first and the second spacers.

Each of the plurality of support bars may include first and second getter fixing parts which are disposed at opposite ends of the support bars and to which some of the plurality of getters are fixed, first and second extension parts which upwardly extend from the first and the second getter fixing parts and a connection part which connects the first and the second extension parts.

The plurality of spacers may include a first spacer and the first and the second extension parts may include first and second elastic deformation parts which are elastically deformed by being brought into contact with both side surfaces of the first spacer.

The first and the second elastic deformation parts are formed by bending the first and the second extension parts.

The first and the second elastic deformation part are elastically deformed to create the pressing force against the both side surfaces of the first spacer.

A distance between the first and the second elastic deformation parts, before the first and the second elastic deformation parts are elastically deformed, may be smaller than a distance between the both side surfaces of the first spacer.

The plurality of spacers may include a first spacer. The coupling bar may include the first and second elastic deformation parts which are elastically deformed by being brought into contact with surfaces located at the first and second ends of the first spacer and a coupling part which is disposed between the first and the second elastic deformation parts and is coupled to the connection parts of the plurality of support bars.

The first and the second elastic deformation parts may be formed by bending the coupling bar.

The first and the second elastic deformation parts 1 and 2 may be elastically deformed to create the pressing force against the surfaces located at the first and the second ends of the first spacer.

An angle formed between the first elastic deformation part and the coupling part, before the first and the second elastic deformation parts are elastically deformed, may be smaller than an angle formed between the upper surface and the surface located at the first end of the first spacer and an angle formed between the second elastic deformation part and the coupling part, before the first and the second elastic deformation parts are elastically deformed, may be smaller than an angle formed between the upper surface and the surface located at the second end of the first spacer.

The surfaces located at the first and the second ends of the first spacer may be inclined so that a length of the upper surface of the first spacer may be longer than a length of a lower surface of the first spacer.

The coupling bar may be perpendicular to the plurality of support bars.

The support unit is made of elastic material.

According to an aspect of another exemplary embodiment, a display apparatus may include the getter assembly as described above.

According to another aspect of the exemplary embodiment, a method for manufacturing a getter assembly includes providing a plurality of getters, fixing the plurality of getters to a support unit and bending the support unit so that the support unit is brought into contact with a plurality of spacers formed in the getter chamber and is elastically deformed.

Additional aspects and advantages of the present inventive concept will be set forth in the detailed description, will be obvious from the detailed description, or may be learned by practicing the invention.

### BRIEF DESCRIPTION OF THE DRAWINGS

The above and/or other aspects will be more apparent by describing in detail exemplary embodiments, with reference to the accompanying drawings in which:

FIG. 1 is a view schematically illustrating a display apparatus according to an exemplary embodiment;

FIG. 2 is a view schematically illustrating a support unit of FIG. 1 according to an exemplary embodiment;

FIG. 3 is a view schematically illustrating a plurality getter fixed to the support unit according to an exemplary embodiment,

FIG. 4 is a view schematically illustrating the support unit bent by a bending process according an exemplary embodiment;

FIG. 5 is a view schematically illustrating a process of mounting a getter assembly in a getter chamber according to an exemplary embodiment;

FIG. 6 and FIG. 7 is views schematically illustrating a getter assembly according to another exemplary embodiment; and

FIG. 8 and FIG. 9 are views schematically illustrating a getter assembly according to yet another exemplary embodiment.

### DETAILED DESCRIPTION

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the invention with unnecessary detail. It should be understood that various elements are not drawn to scale and the dimensions of the various elements may be arbitrarily increased or reduced for clarity of discussion.

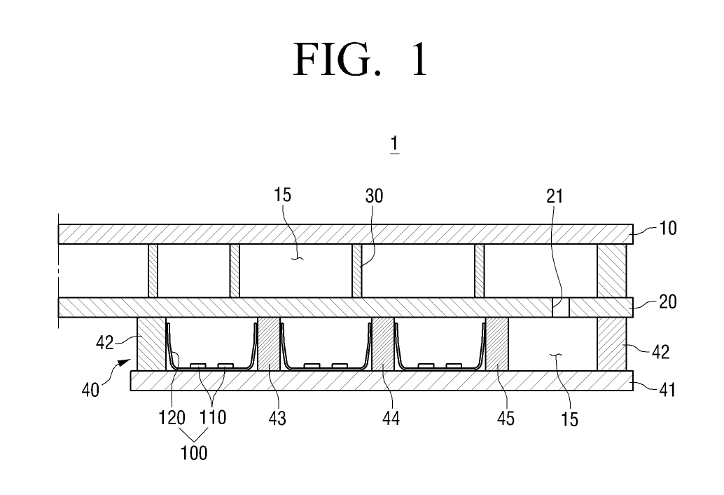

FIG. 1 is a view schematically illustrating a cross sectional view of a display apparatus 1 according to an exemplary embodiment. The display apparatus 1 illustrated in FIG. 1 is the display apparatus which requires a vacuum packaging process, for example plasma display apparatuses, field emission display (FED) apparatuses and Vacuum Fluorescence Display (VFD) apparatuses. Hereinafter, it will be assumed that the display apparatus illustrated FIG. 1 is Field Emission display (FED) for convenience of explanation.

An upper board 10 and a lower board 20 are disposed in parallel with and at a distance from each other. The upper board 10 and the lower board 20 may be glass boards. An anode electrode and a fluorescent screen may be formed in the upper board 10. A cathode electrode and an emitter may be formed in the lower board 20. The emitter in the lower board 20 emits electron due to the potential difference between the anode electrode in the upper board and the cathode electrode in the lower board, and the emitted electron collides with the fluorescent screen in the upper board 10, thereby generating light. The display apparatus 1 is activated by the generated light which beams upwardly. In this case, in order to increase a mean free path of an electron, the space 15 between the upper board 10 and the lower board 20 need to be maintained in the vacuum state at a high level.

A spacer 30 is formed between the upper board 10 and the lower board 20. The spacer 30 may prevent the upper board 10 and the lower board 20 from being deformed by the difference between the pressing force in the space between the upper board 10 and the lower board 20, and the pressing force outside.

In order to vacuumize the space 15 between the upper board 10 and the lower board 20, an exhaustion process is performed during manufacturing the display apparatus 1. However, even after the exhaustion process is performed, a remaining gas exists in the space 15 between the upper board 10 and the lower board 20. The remaining gas may change a work function value of the emitter, shortening the lifespan of the fluorescent screen and hindering the features of emitting electron.

A getter chamber 40 (or a getter room) may be provided for eliminating the remaining gas so that the vacuum state of the space 15 between the upper board 10 and the lower board 20 can be maintained at a desired vacuum value. The getter chamber 40 may be connected to the space 15 between the upper board 10 and the lower board 20 through the connection hole 21 which is formed in the lower board 20. The connection hole 21 is preferably, but not necessarily, to be disposed at the periphery of the lower board 20 in order that the connection hole 21 is disposed out of the effective light-emitting area of the display apparatus 1.

According to an exemplary embodiment illustrated in FIG. 1, the getter chamber 40 is disposed under the lower board 20. This is simply an exemplary embodiment and the location of the getter chamber may be variously changed and modified.

The getter chamber 40 may comprise a getter board 41, sealing materials 42, spacers 43 to 45 and a getter assembly 100.

The getter board 41 and the lower board 20 are disposed in parallel with and in a distance from each other to create the space 50 of the getter chamber 40. The space 50 of the getter chamber 40 is connected to the space 15 between the upper board 10 and the lower board 20 through the connection hole 21.

The sealing materials 42 seal the getter chamber 40 and are formed at the periphery of the getter board 41.

The spacers 43 to 45 are formed between the getter board 41 and the lower board 20. The spacers 43 to 45 may prevent the getter board 41 from being deformed by the difference between the pressing force in the space 50 of the getter chamber 40 and the pressing force outside.

The getter assembly 100 is mounted in the getter chamber 40. The getter assembly 100 may comprise a plurality of getters 110 and a support unit 120 to support the plurality of getters 110. When a getter activation device (not illustrated) activates the getters 110, the activated the getters 110 may absorb the remaining gas, thereby the vacuum value of the space 15 between the upper board 10 and the lower board 20 being maintained at a desired level.

In order to activate the getter 110, the getter activation device may adopt the method of high frequency induction heating. In consideration of the structure of the display apparatus 1, the getter activation device may be disposed under the getter board 41. In order to increase the efficiency of the high frequency induction heating, the getter 110 needs to be disposed close to the getter activation device. Accordingly, as illustrated in FIG. 1, the getter assembly 100 may be mounted to closely contact the upper surface of the getter board 41.

Hereinbefore, an exemplary embodiment where the display apparatus is a field emission display was explained in detail, however, it is understood that the exemplary embodiments may by applied to other type of display apparatus that requires vacuum packaging for example, vacuum fluorescent display or plasma display. According to the type of the display apparatus, the structure of the upper board 10 and the lower board 20 may be changed but it should be understood that the getter chamber in which the getter assembly in mounted absorbs the remaining gas may be applied in the same way to other type of display apparatuses.

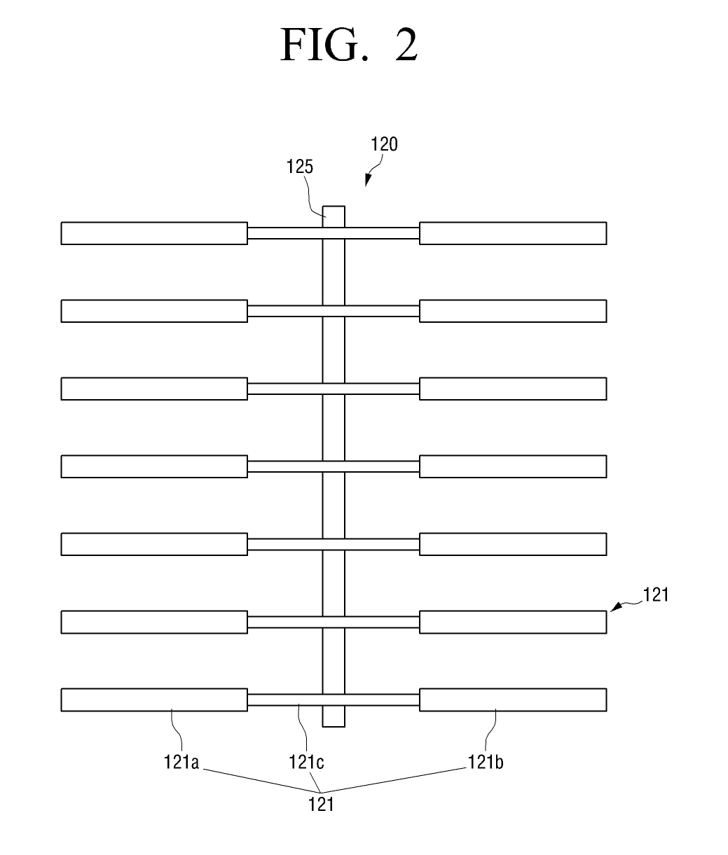

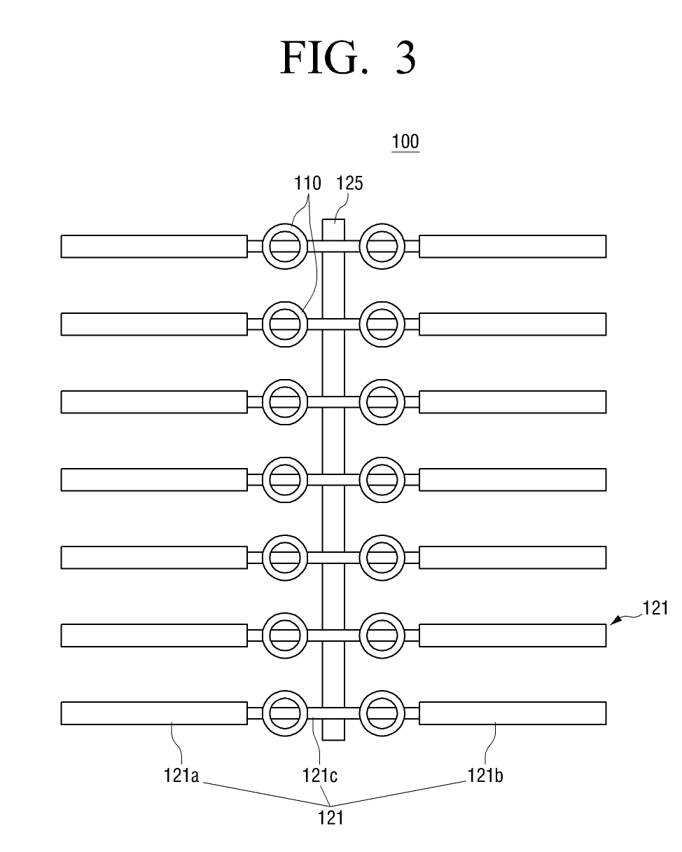

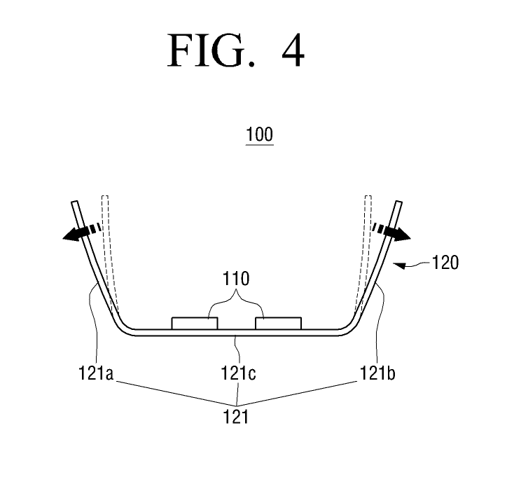

With reference to FIGS. 2 to 4, the getter assembly 100 illustrated in FIG. 1. will be explained in detail. FIG. 2 is a view schematically illustrating the support unit 120 of the getter assembly 100, FIG. 3 is a view schematically illustrating a plurality of getters 110 fixed to a support unit 120 and FIG. 4 is a view schematically illustrating a state where a supportive unit 120 is bent by bending process.

With reference to FIG. 2, the support unit 120 of the getter assembly 100 may comprise a plurality of support bars 121 and a coupling bar 125. The plurality of getters 110 may be fixed to the plurality of support bars 121 (refer to FIG. 3). The coupling bar 125 couples the plurality of support bars 121 and extends across the plurality of support bars 121. The coupling bar 125 may be perpendicular to the plurality of the support bars 121. A support unit 120 may be made of elastic material such as SUS(Steel Use Stainless).

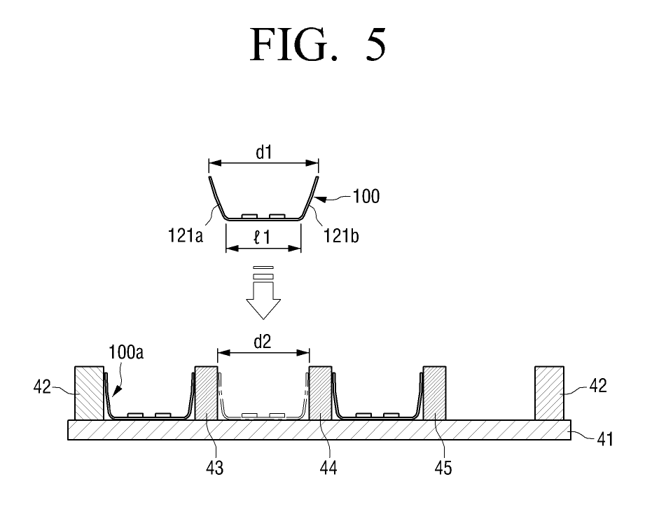

The plurality of support bars 121 may comprise a first and second elastic deformation part 121a, 121b and a getter fixing part 121c. The first and second elastic deformation part 121a, 121b are disposed at opposite or distal ends of the support bars 121 and the getter fixing part 121c is disposed between the first and second elastic deformation part 121a, 121b. The getter fixing part 121c is corresponding to the area where some of the plurality of getters 110 are fixed to. Hereinafter the first and second elastic deformation part 121a, 121b will be explained in detail with reference to FIG. 5.

The width of the first and second elastic deformation part 121a, 121b may be about 2 mm and the width of the getter fixing part 121c may be about 1 mm. The width of the coupling bar 125 may be about 2 mm. However the aforementioned dimensions are exemplary and the widths of the first and second elastic deformation part 121a, 121b, the getter fixing part 121c and the coupling bar 125 may be variously changed and modified. In addition, according to FIG. 2, the width of the first and second elastic deformation part 121a, 121b is illustrated wider than the width of the getter fixing part 121c. However, the width of the first and second elastic deformation part 121a, 121b may be smaller than or the same with the width of the getter fixing part 121c.

With reference to FIG. 3, the plurality of getters 110 are fixed to the getter fixing part 121c of the plurality of support bars 121. In this case, a welding process may be used in order to fix the plurality of getters 110. However, the welding process is exemplary and it is understood that the plurality of getters 110 may be fixed to the getter fixing part 121c by other types of processes. In addition, it is illustrated that two getters 110 are fixed to a single support bars 121 in FIG. 3 but, the number of getters 110 to be fixed to a single support bars 121 may vary.

With reference to FIG. 4, the plurality of support bars 121 are bent by bending process, thereby each of the first and second elastic deformation parts 121a, 121b forming a certain angle with respect to the getter fixing part 121c. Then manufacturing the getter assembly 100 is completed.

If the plurality of support bars 121 are made of elastic material, it is noted that elastic force is generated as the first and second elastic deformation parts 121a, 121b are deformed. For example, if the first and second elastic deformation parts 121a, 121b are deformed as illustrated in broken line in FIG. 4, elastic force will be generated by springback phenomenon. According an exemplary embodiment, the getter assembly 100 is mounted in the getter chamber 40 by the elastic force. Hereinafter with reference to FIG. 5, method to mount the getter assembly 100 will be explained in detail.

FIG. 5 is a view schematically illustrating the process of mounting the getter assembly 100 in the getter chamber 40

According an exemplary embodiment, the getter assembly 100 is mounted between the first and second spacers 43, 44 which are formed adjacent to each other. In this case, a distance d1 between open ends of the first and the second elastic deformation part 121a, 121b is greater than a distance d2 between the first and the second spacers 43, 44 and the length 11 of the getter fixing part 121c is shorter than the distance d2 between the first and the second spacer 43, 44. Accordingly the getter assembly 100 is inserted into the space between the first and second spacers 43, 44, the first and second elastic deformation parts 121a, 121b are elastically deformed by being brought into contact with or by being inserted between the first and second spacers 43, 44, and thereby creating a pressing force against the first and second spacers 43, 44. By this pressing force, the getter assembly 100 may be fixedly maintained in the getter chamber 40.

Hereinbefore, the process of mounting a single getter assembly 100 in the getter chamber 40 was explained in detail, however, it is understood that the other getter assembly may be mounted in the getter chamber by the same method. For example, the getter assembly 100a at the most left side is mounted between the sealing material 42 and the first spacer 43. In this case, sealing material 42 and the first spacer 43 may correspond to the aforementioned the first spacer 43 and the second spacer 44, respectively.

According to an exemplary embodiment, the getter assembly 100 may be mounted in the getter chamber 40 by only inserting the getter assembly 100 into the first and second spacers 43, 44, thus, the manufacturing process may be easier and simpler. In addition, since the getter assembly including the plurality of getters 110 is used, the manufacturing process may be more easier and simpler than when the plurality of getters 110 are separately mounted. Furthermore, the plasticity process is not used to fix the getter assembly 100 to the getter board 41, thereby preventing the plurality of getters 110 from being oxidized and contaminated during the plasticity process.

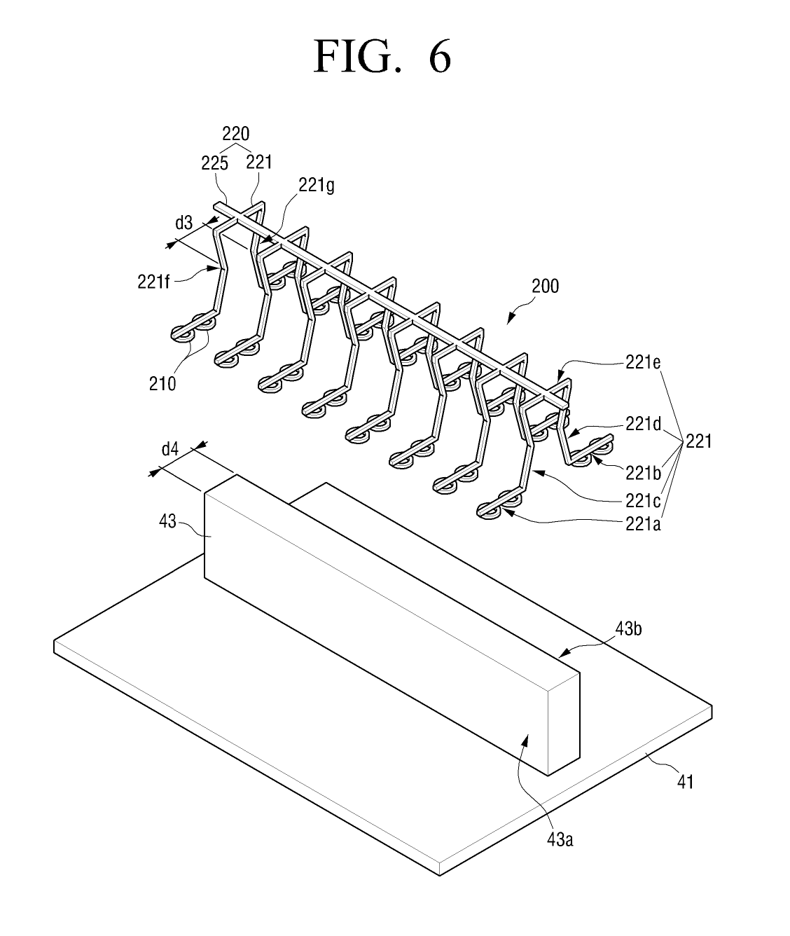

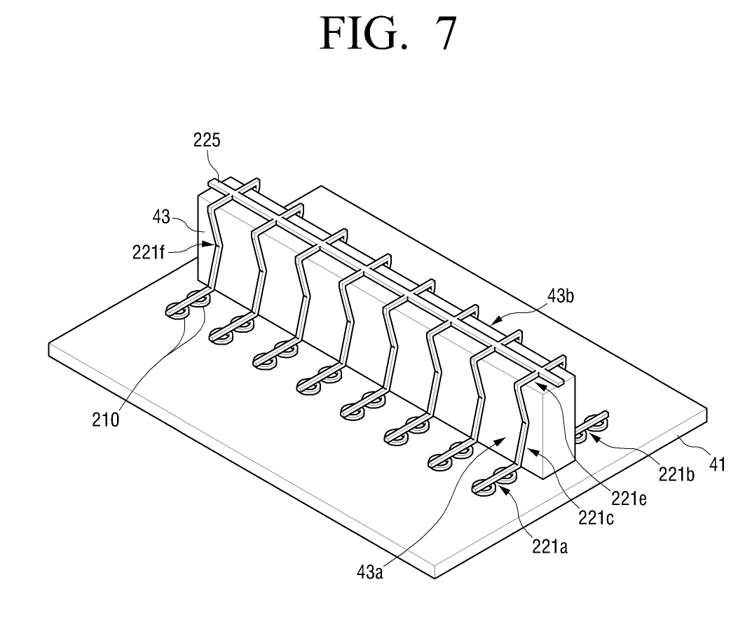

FIG. 6 and FIG. 7 are views schematically illustrating the getter assembly according to another exemplary embodiment. FIG. 6 is a view schematically illustrating the getter assembly 200 before being mounted in and FIG. 7 is a view schematically illustrating the getter assembly 200 after being mounted. For convenience of explanation, FIG. 6 and FIG. 7 illustrate only one single spacer 43.

In contrast to the aforementioned exemplary embodiments, according to yet another exemplary embodiment, the getter assembly 200 is mounted to surround the single spacer 43. This getter assembly 200 comprises a plurality of getters 210 and a support unit 220 to support the plurality of getters 210.

The support unit 220 may comprise the coupling bar 225 which couples a plurality of support bars 221.

Each of the plurality of support bars 221 may comprise the first and the second getter fixing parts 221a, 221b, the first and second extension parts 221c, 221d and the connection part 221e. The first and second getter fixing parts 221c, 221b are disposed at opposite or distal ends of the support bars 221 and some of plurality of getters 210 are fixed to the first and second getter fixing parts 221c, 221d. The first and second extension parts 221c, 221d upwardly extend from the first and second getter fixing parts 221a, 221b. The connection part 221e connects the first and second extension parts 221c, 221d. The first and second getter fixing parts 221a, 221b, the first and second extension parts 221c, 221d and the connection parts 221e may be formed by bending a linear support bars 221.

The coupling bar 225 extends across a plurality of connections parts 221e.

The first extension part 221c comprises the first elastic deformation part 221f which is elastically deformed by being brought into contact with the first side surface 43a of the spacer 43, and the second extension part 221d comprises the second elastic deformation part 221g which is elastically deformed by being brought into contact with the second side surface 43b of the spacer 43. The first and second elastic deformation parts 221f, 221g may be formed by bending the first and the second extension parts 221c, 221d.

As illustrated in FIG. 6, the distance d3 between the first and second elastic deformation parts 221f, 221 is smaller than the distance d4 between the first and second side surfaces 43a, 43b of the spacer 43. Therefore, as illustrated in FIG. 7, when the getter assembly 200 is mounted to surround spacer 43, the first and second elastic deformation parts 221f, 221g are elastically deformed by being brought into contact with the first and second side surfaces 43a, 43b of the spacer 43 and thereby creating a pressing force against the first and second side surfaces 43a, 43b of the spacer 43. The getter assembly may be fixedly maintained in the getter chamber by this pressing force. Where the getter assembly 200 is fixed as illustrated in FIG. 7, the connection part 221e and the coupling bar 225 are disposed on the upper surface of the spacer 43.

In order that the plurality of getters 210 closely contact the upper surface of getter board 41, it is preferable, but not necessary, that a distance from the upper surface of getter board 41 to the lower surface of the coupling bar 225 after the getter assembly 200 is mounted is the same as the height of spacer 43.

Similarly to the aforesaid exemplary embodiments, in this exemplary embodiment, the getter assembly 200 may be fixed by elastic deformation of the support unit 220. Accordingly, manufacturing process becomes easier and simpler, and phenomena of oxidization and contamination may be prevented.

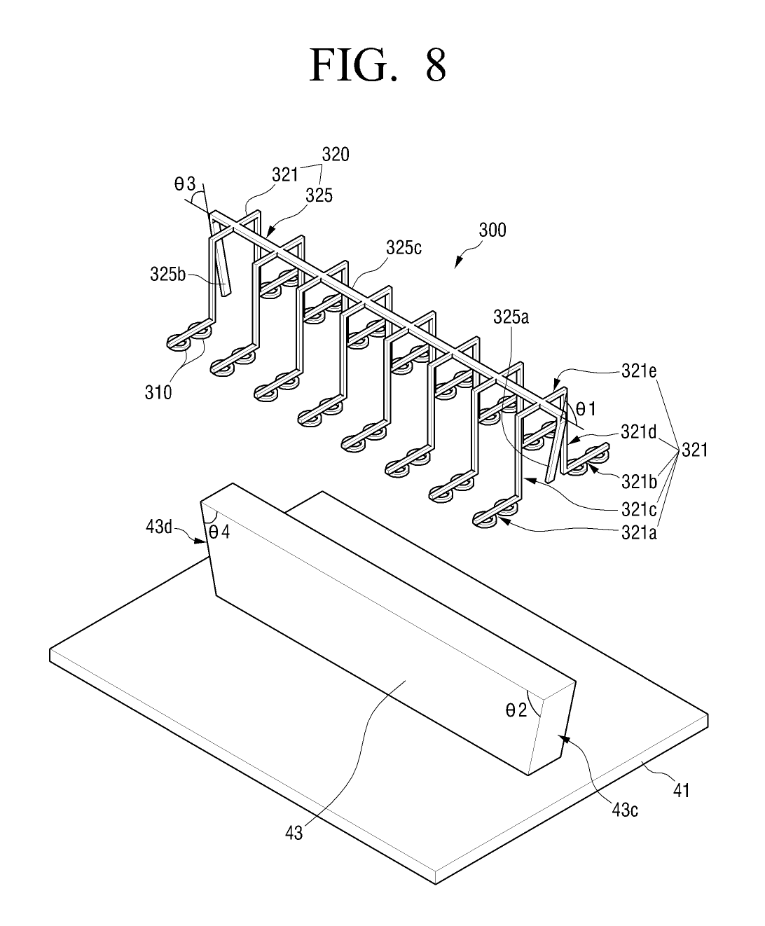

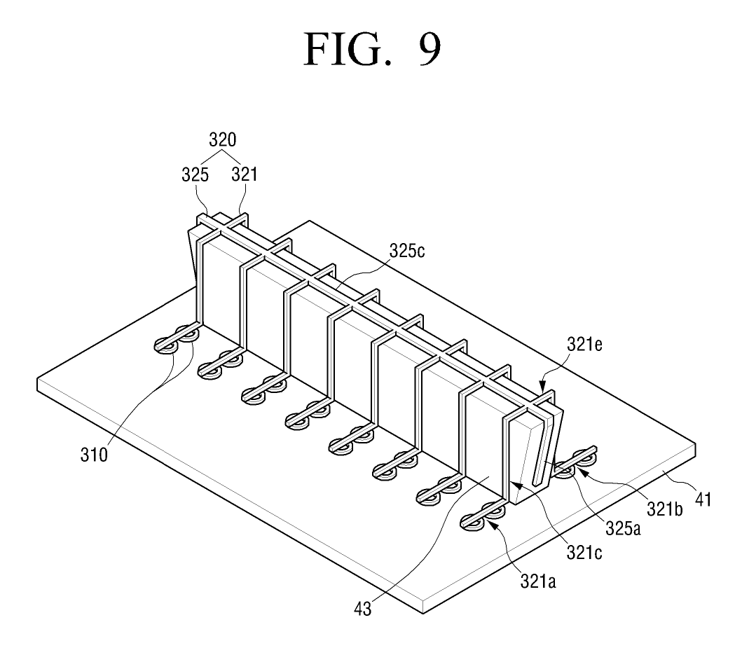

FIG. 8 and FIG. 9 are views schematically illustrating the getter assembly 300 according to another exemplary embodiment. FIG. 8 is a view schematically illustrating the getter assembly 300 before being mounted and FIG. 9 is a view schematically illustrating the getter assembly 300 after being mounted. For convenience of explanation, FIG. 8 and FIG. 9 illustrate only a single spacer 43 as FIGS. 6 and 7.

The getter assembly 300 according to yet another exemplary embodiment is mounted to surround the single spacer 43. This getter assembly 300 comprises a plurality of getters 310 and a support unit 320 which supports the plurality of getters 310.

The support unit 320 may comprise a plurality of support bars 321 and a coupling bar 325 which couples the plurality of support bars 321.

Each of the support bars 321 may comprise the first and second fixing parts 321a, 321b, the first and second extension parts 321c, 321d, and the connection part 321e. The first and second getter fixing parts 321a, 321b are disposed at opposite or distal ends of the support bars 321 and some of the plurality of getters 310 are fixed to the first and second fixing parts 321a, 321b. The first and second extension parts 321c, 321d upwardly extend from the first and second fixing parts 321a, 321b. The connection part 321e connects the first and second extension parts 321c, 321d. The first and second getter fixing parts 321a, 321b, the first and second extension parts 321c, 321d and the connection part 321e may be formed by bending the linear support bars 321.

The coupling bar 325 extends across the connection parts 321e of the plurality of support bars 321. The coupling bar 325 may comprise the first and second elastic deformation parts 325a, 325b and the connection part 325c. The first elastic deformation part 325a, 325b may be elastically deformed by being brought into contact with the surfaces 43c, 43d located at the first and second ends of the spacer 43. The coupling part 325c is disposed between the first and second elastic deformation parts 325a, 325b and is connected to the connection parts 321c of the plurality of support bars 321. The first and second elastic deformation parts 325a, 325b may be formed by bending the linear coupling bar 325.

As illustrated in FIG. 8, an angle θ1 formed between the first elastic deformation part 325a and the coupling part 325c is smaller than an angle θ2 formed between the upper surface and the surface 43c located at the first end of the first spacer, and an angle θ3 formed between the second elastic deformation part 325b and the coupling part 325c is smaller than angle θ4 formed between the upper surface and the surface 43d located at the second end of the spacer 43. Accordingly, as illustrated in FIG. 9, when the getter assembly 300 is mounted to surround the spacer 43, the first and second elastic deformation parts 325a, 325b are elastically deformed by being brought into contact with the surfaces 43c, 43d of spacer 43, and thereby creating a pressing force against the surfaces 43c, 43d of the spacer 43. The getter assembly 300 may be fixedly maintained in the getter chamber by this pressing force. As illustrated in FIG. 9, when the getter assembly 300 is fixed, the connection parts 321e of the plurality of support bars 321 and the coupling part 325c of the coupling bar 325 are disposed on the upper surface of the spacer 43.

As illustrated FIG. 8 and FIG. 9, the surfaces 43c, 43d located at the first and the second ends of spacer 43 are inclined so that a length of the upper surface of spacer 43 is longer than a length of a lower surface of spacer 43. The getter assembly 300 may be fixed more stably by this structure of the spacer 43.

In order that the plurality of getters 310 closely contact the upper surface of the getter board 41, it is preferable, but not necessary, that a distance from the upper surface of getter board 41 to the lower surface of the coupling bar 325 after the getter assembly 200 is mounted is the same as the height of the spacer 43.

Similarly to the two aforementioned exemplary embodiments, in this exemplary embodiment, it is possible to fix the getter assembly 320 using elastic deformation of the support unit 320. Thus, the manufacturing process may be easier and simpler, and phenomena of oxidization and contamination may be prevented.

In this exemplary embodiment, the first and second elastic deformation parts 325a, 325b are formed on the coupling bar 325, but it should be understood that the elastic deformation parts may be formed on a plurality support bars 321 similarly to exemplary embodiments in FIG. 6 and FIG. 7.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A getter assembly for being mounted in a getter chamber in which a plurality of spacers are formed, the getter assembly comprising:
a plurality of getters; and
a support unit which supports the plurality of getters,
wherein, when the getter assembly is mounted in the getter chamber, the support unit is elastically deformed to press against at least one of the plurality of spacers so the getter assembly is fixedly mounted.

2. The getter assembly as claimed in claim 1, wherein the support unit comprises:
a coupling bar;
a plurality of support bars attached to the coupling bar, wherein the plurality of getters are attached to the plurality of support bars

3. The getter assembly as claimed in claim 2, wherein the at least one of the plurality of spacers comprise:
a first spacer and a second spacer adjacent to the first spacer; and
wherein each of the plurality of support bars comprises:
a first elastic deformation part and a second elastic deformation part which are disposed at opposite ends of the support bar and are elastically deformed by being brought into contact with the first and the second spacers; and
a getter fixing part which is disposed between the first and the second elastic deformation parts and to which some of the plurality of getters are fixed.

4. The getter assembly as claimed in claim 3, wherein the first and the second elastic deformation parts are formed by bending the support bar.

5. The getter assembly as claimed in claim 3, wherein the first and the second elastic deformation parts are elastically deformed to press against the first and the second spacers.

6. The getter assembly as claimed in claim 3, wherein a distance between open ends of the first and the second elastic deformation parts of the support bar, before the first and the second elastic deformation parts are elastically deformed, is greater than a distance between the first and the second spacers.

7. The getter assembly as claimed in claim 2, wherein each of the plurality of support bars comprises:
a first getter fixing part and a second getter fixing part which are disposed at opposite ends of the support bar and to which at least one of the plurality of getters are fixed;
a first extension part and a second extension part which upwardly extend from the first and the second getter fixing parts; and
a connection part which connects the first and the second extension parts.

8. The getter assembly as claimed in claim 7, wherein the at least one of the plurality of spacers comprise a first spacer,
wherein the first extension part comprises a first elastic deformation part and the second extension part comprises a second elastic deformation part, the first and the second elastic deformation parts being elastically deformed by being brought into contact with both side surfaces of the first spacer.

9. The getter assembly as claimed in claim 8, wherein the first and the second elastic deformation parts are formed by bending the first and the second extension parts.

10. The getter assembly as claimed in claim 8, wherein the first and the second elastic deformation part are elastically deformed to press against the both side surfaces of the first spacer.

11. The getter assembly as claimed in claim 8, wherein a distance between the first and the second elastic deformation parts, before the first and the second elastic deformation parts are elastically deformed, is smaller than a distance between the both side surfaces of the first spacer.

12. The getter assembly as claimed in claim 7, wherein the at least one of the plurality of spacers comprises a first spacer,
wherein the coupling bar comprises:
a first elastic deformation part and a second elastic deformation part which are elastically deformed by being brought into contact with surfaces located at a first end and a second end of the first spacer; and
a coupling part which is located between the first and the second elastic deformation parts and is coupled to the connection parts of the plurality of support bars.

13. The getter assembly as claimed in claim 12, wherein the first and the second elastic deformation parts are formed by bending the coupling bar.

14. The getter assembly as claimed in claim 12, wherein the first and the second elastic deformation parts are elastically deformed to press against the surfaces located at the first and the second ends of the first spacer.

15. The getter assembly as claimed in claim 12, wherein an angle formed between the first elastic deformation part and the coupling part, before the first and the second elastic deformation parts are elastically deformed, is smaller than an angle formed between an upper surface and the surface located at the first end of the first spacer, and
wherein an angle formed between the second elastic deformation part and the coupling part, before the first and the second elastic deformation parts are elastically deformed, is smaller than an angle formed between the upper surface and the surface located at the second end of the first spacer.

16. The getter assembly as claimed in claim 2, wherein the surfaces located at the first and the second ends of the first spacer are inclined so that a length of an upper surface of the first spacer is longer than a length of a lower surface of the first spacer.

17. The getter assembly as claimed in claim 2, wherein the coupling bar is perpendicular to the plurality of support bars.

18. The getter assembly as claimed in claim 1, wherein the support unit is made of an elastic material.

19. A display apparatus comprising the getter assembly according to claim 1.

20. A method for manufacturing a getter assembly, the method comprising:
providing a plurality of getters;
fixedly attaching the plurality of getters to a support unit; and
bending the support unit so that the support unit is brought into contact with at least one of a plurality of spacers about a getter chamber and is elastically deformed.
